(19) United States
(12) Patent Application Publication
(10) Pub. No.: US 2026/0183581 A1
(43) Pub. Date: Jul. 2, 2026

(54) ACTUATOR HOUSING

(71) Applicant: BELIMO Holding AG, Hinwil (CH)

(72) Inventors: Mario FIORUCCI, Winterthur (CH); Michael BAUERNSCHMITT, Wetzikon (CH)

(21) Appl. No.: 19/427,728

(22) Filed: Dec. 19, 2025

(30) Foreign Application Priority Data
Dec. 27, 2024 (DE) 10 2024 139 824.8

(51) Int. Cl. A62C 2/24

(52) U.S. Cl. CPC A62C 2/247

(57) ABSTRACT

An actuator housing for accommodating an actuator for fire and smoke protection applications (F&S). The actuator housing comprising a first receiving space for accommodating a first group of components of the actuator and a second receiving space for receiving a second group of components of the actuator. The first receiving space and the second receiving space have different degrees of protection.

### CROSS-REFERENCE TO RELATED APPLICATIONS

This application is based on and claims priority to German Patent Application No. 10 2024 139 824.8, filed on December 27, 2024, and entitled “ACTUATOR HOUSING,“ the disclosure of which is herein incorporated by reference in the entirety.

### TECHNICAL FIELD

This application relates to an actuator housing, in particular to an actuator housing for accommodating an actuator for fire and smoke protection applications (F&S), comprising a receiving space for accommodating components of the actuator.

### BACKGROUND

Fires and smoke pose a significant threat to people and property in buildings. In an emergency, fire protection saves lives and helps to prevent damage to property. The spread of fire and smoke through air ducts may be prevented by fire dampers, which may be triggered by a fire detector, a smoke detector, a thermal fuse and/or a temperature sensor. Another application is smoke extraction dampers, in which the damper blades open in the event of smoke. The damper may be opened or closed by motorized actuators. In an emergency, the safety actuators for dampers automatically move to a safety position. On the one hand, fire damper actuators, which close dampers in the event of a fire, and smoke extraction damper actuators, which move dampers to a defined open or closed safety position when smoke develops, have some similarities, but on the other hand they have different functional requirements. Fire protection actuators usually have a spring to close the damper in the event of a fire, whereas smoke extraction damper actuators do not necessarily have a spring. Another kind of fire and smoke protection actuators (F&S actuators) may be used for smoke protection or for combined fire and smoke protection dampers. They may have a spring to close these dampers in the event of a fire or smoke situation. The spring typically triggers the safety position to prevent the spread of smoke or fire. Furthermore, these actuators may be used for specific control of smoke extraction or for the formation of pressure zones. For this purpose they are connected to a building automation system (BAS) or a fire alarm system, for example.

Such fire damper actuators are disclosed, for example, in publication WO2015/135988 A1, and smoke extraction damper actuators in publication WO2020/126165 A1.

The actuators used for fire protection and smoke extraction applications have mechanical (gear) components and electronic or electromechanical components (e.g. PCB) that are arranged in an actuator housing. At least to some of these components different requirements and degrees of protection with regard to the sealing of the housing may apply.

Therefore, there is a need to provide an actuator housing, in particular an actuator housing for accommodating an actuator for fire and smoke protection applications (F&S), which is simple in construction and in which actuator components are securely arranged.

### SUMMARY

An actuator housing according to the disclosure, in particular an actuator housing for accommodating an actuator for fire and smoke protection applications (F&S – Fire & Smoke), comprises: a first receiving space for accommodating a first group of components of the actuator; and a second receiving space for accommodating a second group of components of the actuator; wherein the first receiving space and the second receiving space have different degrees of protection. The actuator housing comprises a first assembly forming a mechanical support structure and a second assembly forming, inter alia, housing walls, and wherein the second assembly comprises at least two housing shells forming side walls of the actuator housing.

The actuator housing preferably has a first assembly that forms a mechanical support structure and a second assembly that forms, inter alia, housing walls. The support structure is usually metallic and/or fire-resistant.

The aforementioned fire and smoke protection applications may include fire protection (e.g. spring return drives) and smoke extraction damper drives (without springs) as well as drives for combined fire protection and smoke extraction dampers (with a spring).

In particular, the first group of components substantially comprises mechanical components or gearing components, and the second group of components substantially comprises electronic or electromechanical components.

Accordingly, the F&S actuator housing has two different compartments:

A ‘sealed gearbox compartment’ with a lower degree of protection (e.g. with a degree of protection of IP 40, but not limited to this) for housing mechanical components such as: gearbox, spring, locking lever (which mechanically blocks the spring return movement), freewheel, overload clutch, etc. The selected degree of protection is intended to ensure protection in particular against sand and particles as well as protection against environmental influences.

A ‘sealed electronics compartment’ with a higher degree of protection (e.g. with a degree of protection of IP 54, but not limited to this) for housing electronic and electromechanical components such as: circuit board (PCB), motor, electromechanical auxiliary switches, etc.

The first assembly comprises, in particular, at least a first (e.g. lower) support plate and a second (usually arranged parallel to the first support plate, e.g. upper) support plate. The support plates preferably form the upper and lower walls of the actuator housing. The parallel intermediate plate, together with the lower support plate, delimits the space for the gearbox.

The first assembly comprises, in particular, at least one intermediate plate arranged parallel to the support plates. The spring of the spring return drive is attached to the intermediate plate and closes a ventilation damper in the event of fire or smoke.

The first assembly may comprise several (hollow) columns/rods connecting the support plates and/or the intermediate plate.

The second assembly may comprise at least two housing shells, preferably made of plastic, which form, inter alia, side walls of the housing.

The housing shells may be arranged at least partially between the intermediate plate and the second (e.g. upper) support plate. Gear components may be arranged between the intermediate plate and the first (e.g. lower) support plate. The housing shells may be arranged (in a sandwich-like manner) between the intermediate plate and the upper support plate. The two housing shells form the lateral outer walls of the actuator housing.

The housing shells are sealed and form the sealed, e.g. IP54-protected, volume for electronic components and the side walls of the actuator housing. The housing shells preferably delimit the second receiving space with a higher degree of protection, as electronic components must be protected against water (hence, for example, protection class IP54), whereas mechanical components primarily only need to be protected against certain mechanical influences (hence, for example, a protection class that is intended to protect against the ingress of sand and particles). Protection class IP54 specifies that the internal components must remain dry when splashed with water from all directions. Enclosures with a lower protection class protect against foreign particles. However, the disclosure is not limited to these protection classes.

The closed housing has various through-openings for receiving the output shaft, the locking lever, the manual override and the spring axle, as well as for the hollow columns, e.g. six (6) hollow columns, of the mechanical structure. The through-openings are intended to accommodate parts of the mechanical support structure and/or rotating mechanical components.

The lower housing shell has openings for components that are connected to the electronics and the gearbox sealing chamber.

In particular, a sealing arrangement is arranged between the housing shells, which seals the space between the housing shells and the second receiving chamber with regard to openings or through-openings formed in the housing shells.

The hollow columns may protrude through openings in the housing shells, and the sealing arrangement may enclose the openings.

Radial seals are located between the two shells. The outer (IP54) seal between the housing shells surrounds the hollow columns in particular to seal the gearbox from the environment and internally to protect the ‘sealed electronics compartment’. For the rotating components (openings for cams and potentiometer shaft), dynamic radial seals and a static seal for the EMC spring, which may be designed as a membrane that may be pierced, are used. In addition, a static axial seal is provided for the motor.

An example of a system comprises an actuator housing as described above and an actuator (drive).

An example of a method for constructing the system, in particular the system specified above, comprises the following steps:

Providing a first assembly and a second assembly, wherein the second assembly has an upper housing shell and a lower housing shell, wherein the housing shells comprise openings for receiving (hollow) columns of the first assembly;

Assembling the housing shells so that they form a second receiving space (E) in which substantially the electronic or electromechanical components of the actuator are arranged;

arranging the (hollow) columns substantially perpendicular to a first support plate of the first assembly;

arranging the second assembly and the columns relative to each other so that the columns protrude through the openings;

arranging a second support plate relative to the first support plate so that the support plates are connected by the columns, wherein the housing shells and the support plates form a first receiving space (M) for further components of the actuator.

### BRIEF DESCRIPTION OF THE DRAWINGS

FIG. 1 shows a perspective view of a first assembly of an actuator housing;

FIG. 2 shows a perspective view of a second assembly of an actuator housing;

FIG. 3 shows a perspective view from above and below, respectively, of the second assembly from FIG. 2 in an assembled state;

FIG. 4 shows a perspective view of the actuator housing assembled from, inter alia, the first assembly of FIG. 1 and the second assembly of FIG. 2;

FIG. 5 shows an exploded view of the actuator housing of FIG. 4;

FIG. 6 shows a side sectional view of the actuator housing of FIG. 4;

FIG. 7 shows a top view from below and from above of an upper housing shell and a lower housing shell of the actuator housing of FIG. 4;

FIG. 8 shows components of the actuator housing of FIG. 4;

FIG. 9A, 9B show a sectional view of the upper housing shell and the lower housing shell of the actuator housing of FIG. 4 with a sealing concept;

FIG. 10 shows a perspective view of the actuator housing according to a further embodiment.

### DETAILED DESCRIPTION

The following figures illustrate an embodiment of a concept for an actuator housing 1 for accommodating an actuator for fire and smoke protection applications (F&S).

The housing 1 substantially comprises two assemblies 2 and 3.

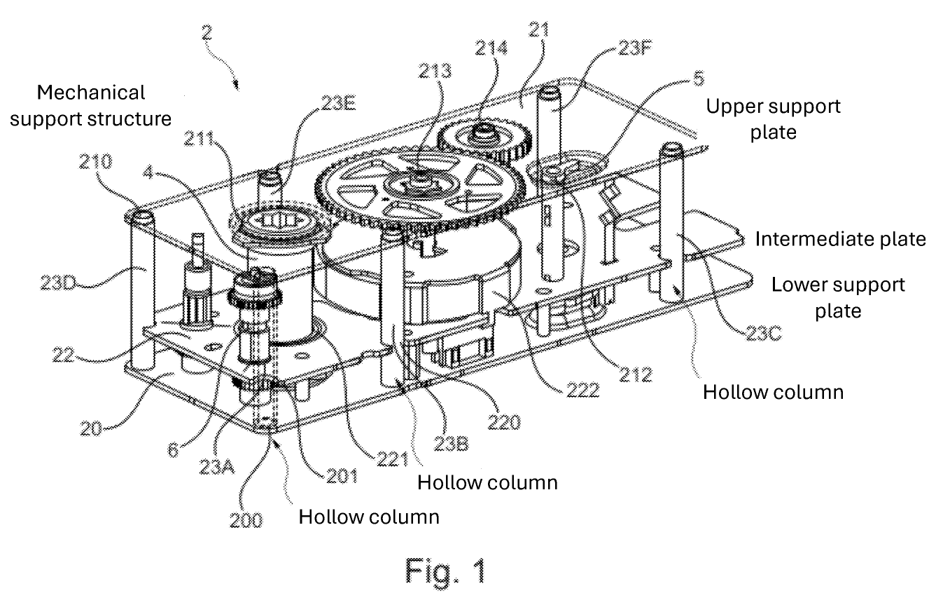

The first assembly 2 is a mechanical support structure which, in accordance with the intended use in fire and smoke applications, is fireproof. The first assembly 2 is shown in more detail in FIG. 1. It has a lower support plate 20, an upper support plate 21 and an intermediate plate 22 arranged between them. The plates 20, 21 and 22 are connected to each other by a number (here 6) of hollow rods (columns) 23A-23F. The support plates 20, 21 and/or the intermediate plate 22 are aligned parallel to each other. The lower and upper ends of the hollow rods 23A-23F are fitted into matching receptacles 200, 210 in the lower support plate 20 and the upper support plate 21 (shown by way of example using hollow rods 23A and 23D). The hollow columns or rods 23A-23F also extend through matching recesses 210 (shown by way of example using hollow rod 23B) in the intermediate plate 22.

The use of the terms ‘upper’ and ‘lower’ is not intended to be restrictive, but only to facilitate the visualization of the arrangements. The terms are interchangeable.

The plates 20, 21, 22 each have various openings or cut-outs for different components of the actuator. For example, all plates 20, 21, 22 have a corresponding cut-out 201, 211, 221 for a continuous hollow shaft 4 of an actuator.

The upper plate 21 also has an opening 212 for a hand lever 5 and bearings 213, 214 for various rotary axes.

The lower plate 20 also has bearings for rotary axes or mountings of components, e.g. of a potentiometer shaft 6 or of the rotary axis of a hand lever 5.

The intermediate plate 22 has further through-holes for components, e.g. for the potentiometer shaft 6, for the axis of the hand lever 5, or for other rotary axes. In the middle area, the intermediate plate 22 has a return spring 222 of a spring return drive of the F&S application attached to the upper side of the intermediate plate 22. In addition, recesses 220 are provided for the passage of the hollow rods 23A-23F.

The structure 2 is overall a mechanical support structure which consists substantially (in particular completely) of metal and is fireproof. A gear is arranged between the intermediate plate 22 and one of the support plates 20, 21. In the embodiment disclosed in the drawings it is arranged between the intermediate plate 22 and the lower support plate 20. The lower and upper support plates 20, 21 form an outer lower wall and an outer upper wall, respectively, of the actuator housing 1.

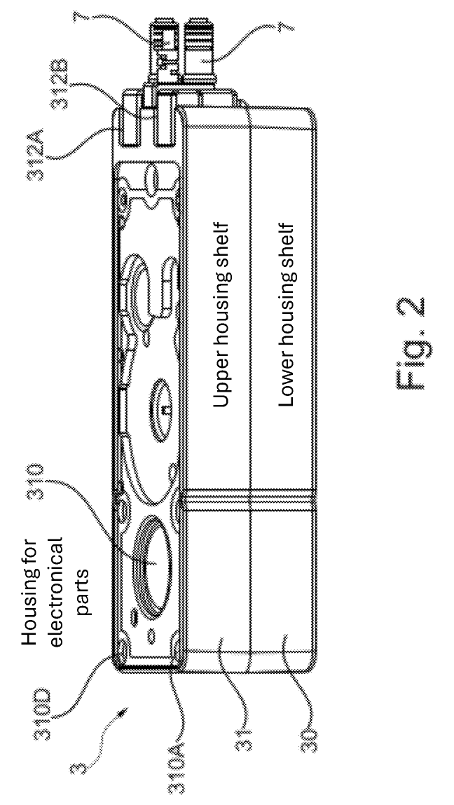

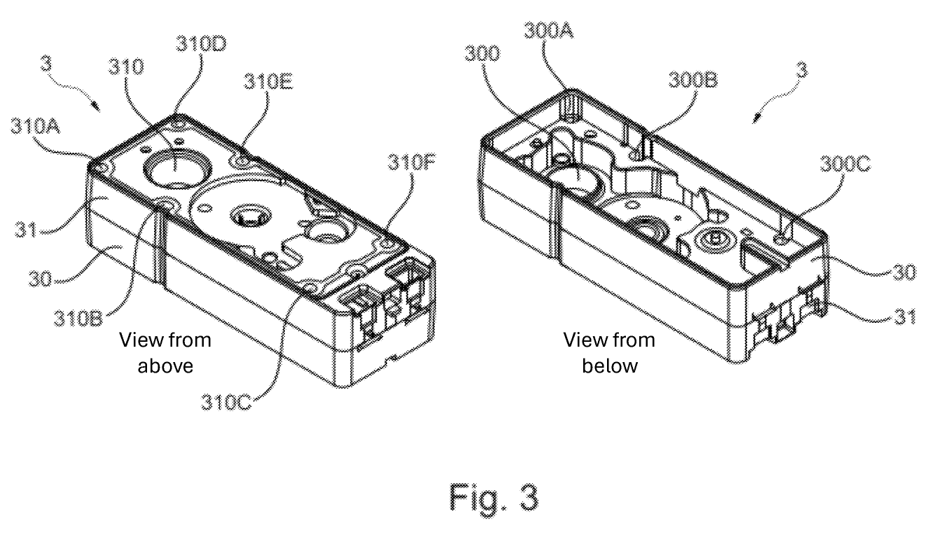

The second assembly 3 is shown in more detail in FIGS. 2 and 3. It comprises a lower housing shell 30 and an upper housing shell 31. In both housing shells 30, 31, corresponding to the openings 201, 211, 221 of the first structure, an opening 300, 310 is formed for a hollow shaft 4 reaching through the opening. Further openings 300A-300F and 310A-310F are provided for the accommodation of the hollow rods 23A-23F of the first assembly (mechanical support structure) reaching through them. In addition, further openings and/or receptacles are provided for accommodating components (such as a potentiometer shaft, return spring and/or rotating mechanical components such as rotary axes) which are formed in one or both of the housing shells 30, 31.

FIG. 2 shows connections 7 which, although not belonging to the second assembly 3, are inserted into corresponding recesses 312A, 312B in the upper housing shell 31.

In particular, the housing shells 30, 31 are made of plastic. Particularly, the plastic complies with flame retardant standards, i.e. minimum requirements for flammability are met. The side walls of the upper housing shell 31 and the lower housing shell 30 together form the side walls of the actuator housing 1.

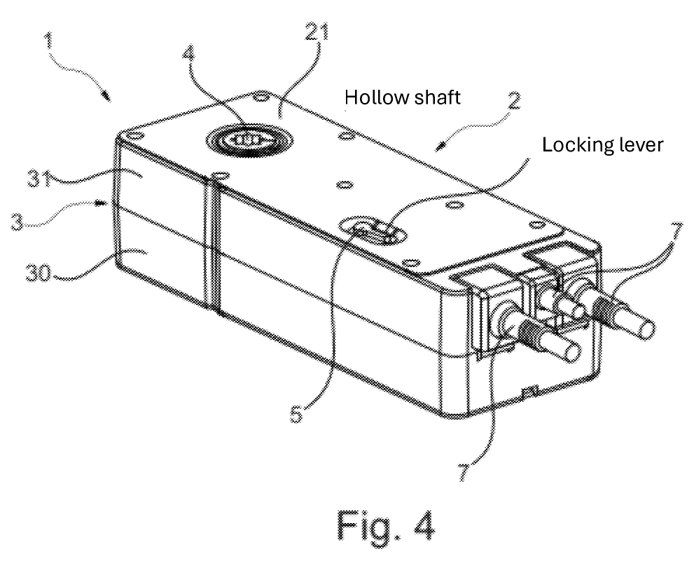

FIG. 4 shows the first assembly 2 and the second assembly 3 in an assembled state. The illustration clearly shows that the first assembly (lower and upper plates 20, 21) forms the lower wall and the upper wall of the housing 1, while the shells 30, 31 form the side walls of the housing 1. Openings for the hollow shaft 4 and a hand lever 5 are visible at the top.

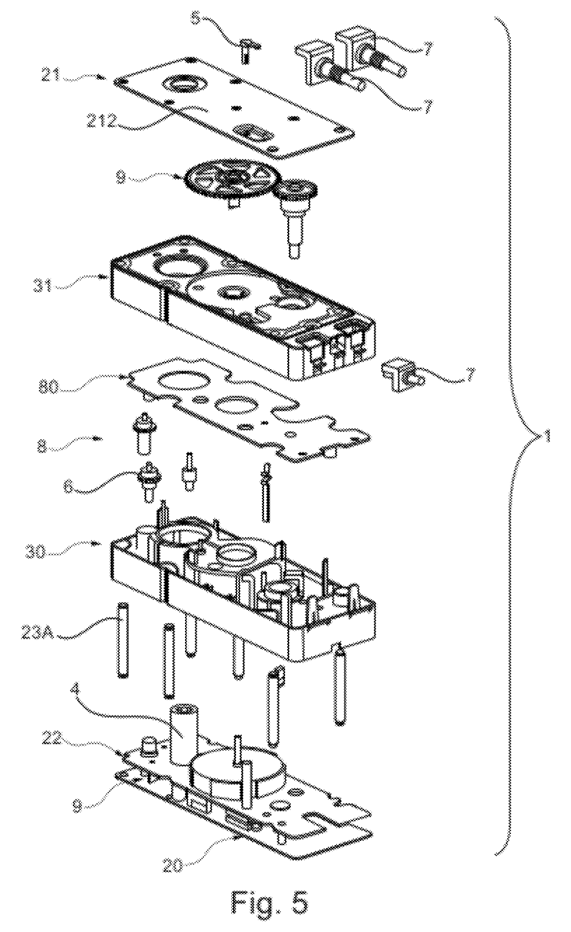

FIG. 5 shows an exploded view of the components of the housing 1 in an arrangement in which the components are assembled. The lower wall of the housing 1 forms the lower plate 20 of the first assembly 2. The intermediate plate 22 is arranged above it. A first receiving space or a first sub-housing for mechanical components 9 (such as gears, including springs) is arranged between the lower plate 20 and the intermediate plate 22. The hollow shaft 4 is inserted into corresponding openings.

The lower shell 30 is placed on top of this structure. It forms the side wall of the first receiving space or the first sub-housing. Furthermore, it forms the underside of a second receiving space or a second sub-housing for electronic components 8, e.g. a printed circuit board (PCB) 80, a potentiometer, electromechanical auxiliary switches and EMC contacts. The second shell 31 is placed on top of the first shell 30, which together with the first shell forms the second receiving space or the second sub- housing, in which, for example, the circuit board 80 is located. Further mechanical components 9 (freewheel and overload clutch) are arranged on or above the second shell 31, and the connections 7 are arranged on the side.

The upper plate 21 attached to the upper shell 31 forms the upper wall or upper end of the housing 1. The locking lever 5 is inserted into a recess 212 formed in the upper plate 21.

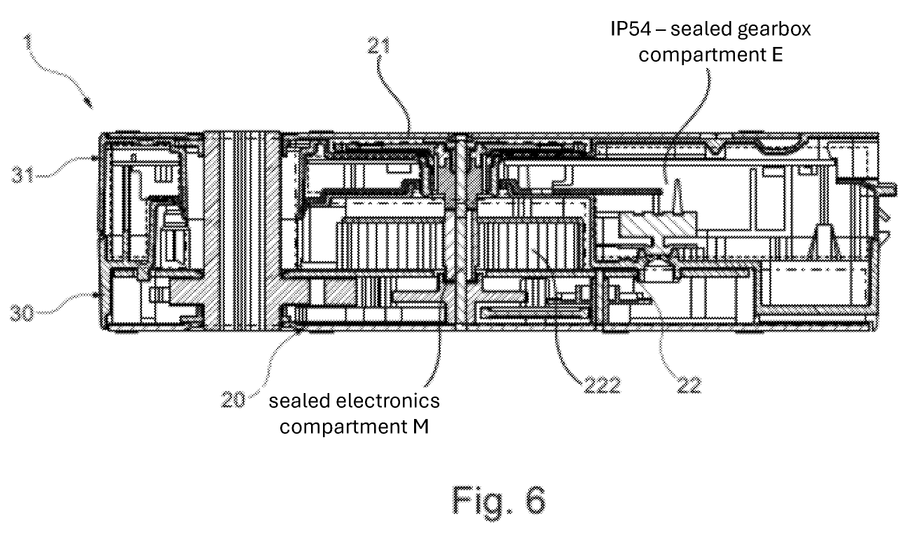

FIG. 6 clearly shows that assemblies 2 and 3 together form a first receiving space M, defined by a first sub-housing, and a second receiving space E, defined by a second sub-housing. The first receiving space M is a ‘sealed gearbox compartment’ (e.g. with protection class IP 40 according to DIN EN 60529) for accommodating mechanical components such as gearboxes, springs, locking levers (that keep the damper closed in the event of a fire), freewheel and overload couplings. The first housing space M is defined by the lower plate 20 (e.g. support plate), a parallel intermediate plate 22, and laterally by a section of the lower shell 30. The spring 222 is attached to the intermediate plate 22 in a structure with a downwardly open cavity of the first sub-housing, which closes a fire protection damper of a ventilation duct (not shown) of a fluid system in the event of fire or smoke.

The second housing space E is a ‘sealed electronics compartment’ (e.g. with protection class IP 54 according to DIN EN 60529) and is intended to accommodate electronic and electromechanical components, such as circuit boards, motors and electromechanical auxiliary switches. The housing space E is defined by the upper housing shell 31 and the lower housing shell 31. Parts of the shells 30, 31 form the side walls of the actuator housing 1. The housing shells 30, 31 are arranged between the upper support plate 21 and the intermediate plate 22.

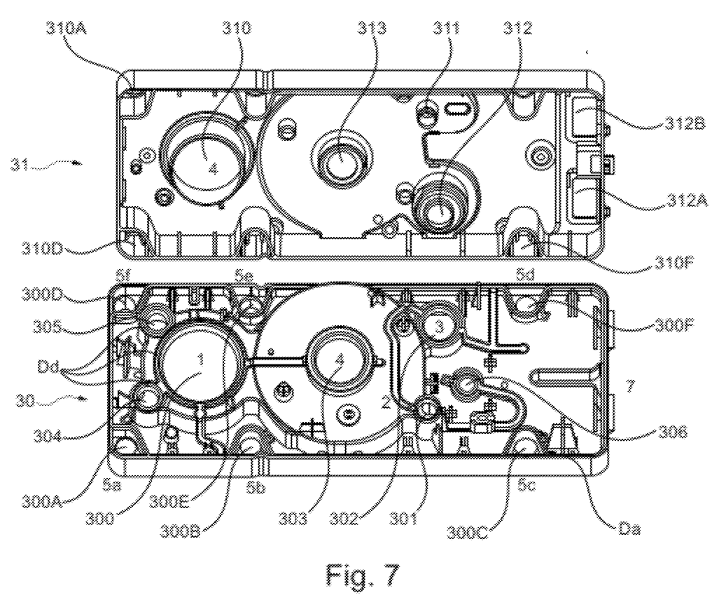

As may be clearly seen particularly from FIG. 7, the closed housing 1 (like the shells 30, 31) has various openings or through-holes. The upper shell 31 (top) is shown from below, and the lower shell 30 (bottom) is shown from above. The upper shell 31 has openings for the hollow shaft (310), the locking lever (311), the manual adjustment (312), the spring axle (313) and for six hollow columns (310A-310F) of the mechanical structure 2. The lower shell 30 has openings for the hollow shaft (300), the locking lever (301), the manual adjustment (302), the spring axle (303) and for six hollow columns (300A-300F) of the mechanical structure 2. In addition, the lower shell 30 has openings for components that are connected to both the first receiving space M and the second receiving space E, namely the rotating components potentiometer shaft (304) and the switching cams (305). The EMC spring (306) and the motor are also connected to both the first receiving space M and the second receiving space E, but statically.

In order to seal the second housing space E with a higher degree of protection (e.g. IP 54 according to DIN EN 60529), seals are arranged between the shells 30, 31 as follows:

Static axial seals for the motor; dynamic radial seals for the rotating components.

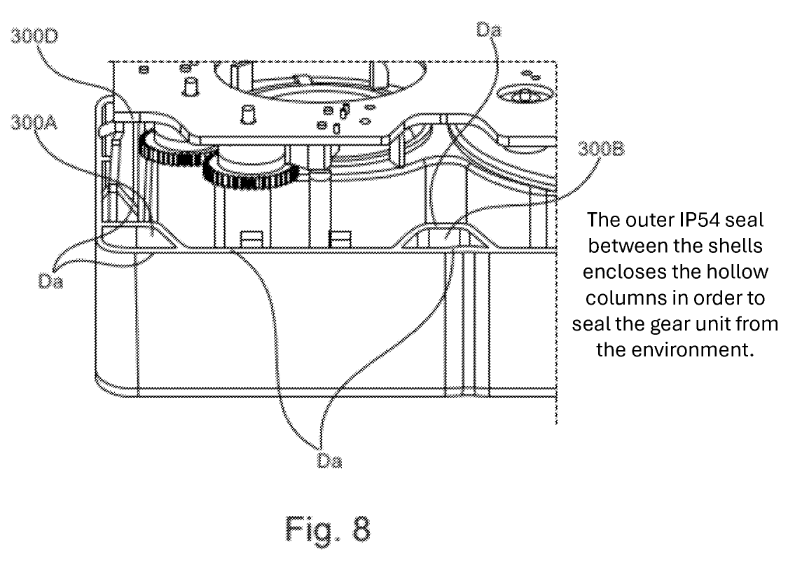

The outer seal Da between the housing shells 30, 31 completely encloses the passages 300A-300F and 310A-310F provided for the hollow columns 23A-23F, as also shown in FIG. 8 by way of example. Dynamic radial seals Dd for the rotating components are provided, for example, for the shaft, potentiometer shaft (304) and switching cam (305), while the static motor components are sealed by static axial seals.

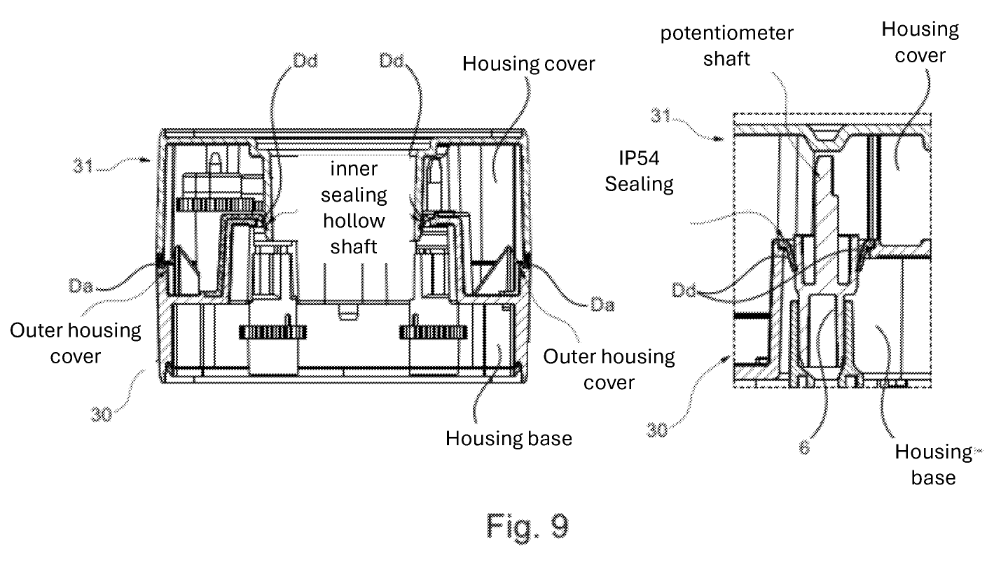

The lower housing shell 30 and the assembled housing shells 30, 31 and their sealing concept are shown in FIGS. 8 and 9A /9B, respectively.

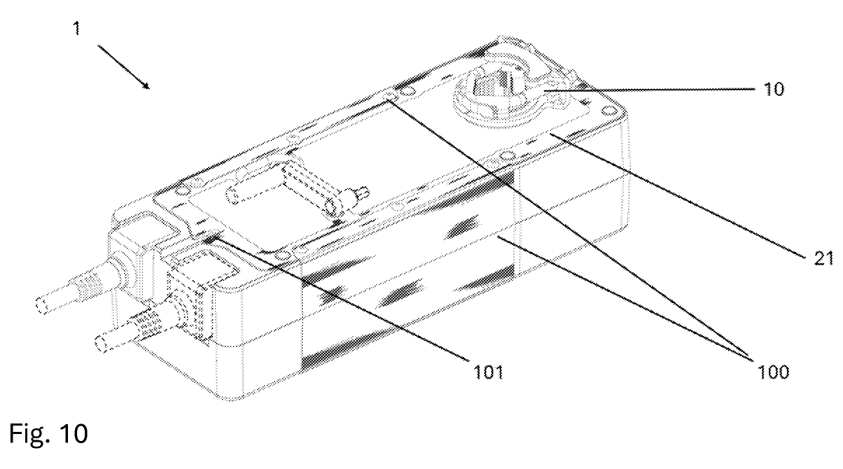

FIG. 10 shows a perspective view of the actuator housing according to a further embodiment. This embodiment is adapted for an alternative mounting method, which differs from a primary method wherein the housing is fastened via screws passing through the hollow columns 23A-23F. While this primary method provides a very stable connection, it requires concentric alignment and generally precludes the use of a non-centric clamping block.

in the embodiment according to FIG. 10, the actuator comprises a clamping block 10 for coupling to a damper shaft. The housing itself is then secured against rotation by a single fixing element, such as a screw or bolt, that passes through a mounting slot 101 and fastens to a wall of the damper system. A mounting slot 101 is formed in both the first and the second support plate 20, 21 at a distance from the hollow shaft 4.

The elongated, longitudinal nature of the slot 101 allows the actuator housing to compensate for misalignments or positional eccentricities, particularly those arising from the use of a non-centric clamping block. To withstand the increased torsional stress associated with this single-point anti-rotation mounting, the housing is reinforced with side reinforcement plates 100 that connect the first and second support plates 20, 21.

1. An actuator housing for accommodating an actuator for fire and/or smoke protection applications (F&S), comprising:
a first receiving space configured to accommodate a first group of components of the actuator; and
a second receiving space configured to accommodate a second group of components of the actuator;
wherein the first receiving space and the second receiving space have different degrees of protection,
wherein the actuator housing comprises a first assembly forming a mechanical support structure and a second assembly forming inter alia housing walls, and
wherein the second assembly comprises at least two housing shells which form side walls of the actuator housing.

2. The actuator housing according to claim 1, wherein the first group of components comprises mechanical components or gearing components, and the second group of components comprises electronic or electromechanical components.

3. The actuator housing according to claim 2, wherein the first assembly comprises at least one first support plate and one second support plate which form a base and a cover of the actuator housing, respectively.

4. The actuator housing according to claim 3, wherein the first assembly comprises at least one intermediate plate arranged parallel to the support plates.

5. The actuator housing according to claim 3, wherein the first assembly comprises a plurality of columns connecting at least two of the support plates and the intermediate plate.

6. The actuator housing according to claim 1, wherein the housing shells form the side walls of the actuator housing.

7. The actuator housing according to claim 4, wherein the housing shells are arranged at least partially between the intermediate plate and the second support plate.

8. The actuator housing according to claim 1, wherein the housing shells have walls which laterally enclose the second receiving space.

9. The actuator housing according to claim 1, wherein a sealing arrangement is arranged between the housing shells to seal the space between the housing shells and the second receiving space with regard to openings or through-openings formed in the housing shells.

10. The actuator housing according to claim 9, wherein the columns protrude through openings formed in the housing shells, and wherein the sealing arrangement surrounds the openings.

11. A system comprising an actuator and an actuator housing according to claim 1.

12. A method for assembling the system according to claim 11, comprising the following steps:
assembling housing shells of a first assembly and a second assembly, wherein the second assembly has an upper housing shell and a lower housing shell, wherein the housing shells comprise openings configured to receive columns of the first assembly, wherein assembling the housing shells forms a second receiving space in which the electronic or electromechanical components of the actuator are arranged;
arranging the columns at an angle relative to a first support plate of the first assembly;
arranging the second assembly and the columns relative to each other so that the columns protrude through the openings,
arranging a second support plate relative to the first support plate so that the support plates are connected by the columns, wherein the housing shells and the support plates form a first receiving space configured to receive further components of the actuator.

13. An actuator housing for accommodating an actuator for fire and/or smoke protection applications (F&S), comprising:
a fire-resistant mechanical support structure comprising a first support plate, a second support plate arranged parallel to the first support plate, and a plurality of hollow columns connecting the first and second support plates; and
at least two housing shells made of a plastic material, the housing shells defining openings through which the plurality of hollow columns pass; wherein the housing shells are arranged between the first and second support plates and form side walls of the actuator housing, thereby defining a sealed electronics compartment configured to house electronic components; and wherein a sealing arrangement forms a seal between the housing shells and around the hollow columns where they pass through the openings.

14. The actuator housing of claim 2, wherein the mechanical components comprise a spring return drive and the electronic components comprise a motor configured to tension the spring.

15. The actuator housing of claim 4, wherein the first receiving space is defined between the first support plate and the intermediate plate, and wherein the second receiving space is at least partially defined between the intermediate plate and the second support plate.

16. The actuator housing of claim 9, wherein the sealing arrangement comprises a static outer seal that circumferentially surrounds the openings of the columns.

17. The actuator housing of claim 16, wherein the sealing arrangement further comprises dynamic radial seals configured to seal rotating components that pass through one of the housing shells.

18. The actuator housing of claim 13, wherein the fire-resistant mechanical support structure is made of metal, and the housing shells are made of a flame-retardant plastic.

19. The actuator housing according to claim 3, further comprising: a pair of side reinforcement plates extending between and connecting the first support plate and the second support plate to increase a torsional rigidity of the housing,
wherein a mounting slot is formed in at least the first or the second support plates at a longitudinal end of the support plate, the mounting slot being located at a distance from the hollow shaft; wherein the mounting slot is configured to receive an anti-rotation fixing element, wherein the anti-rotation fixing element is configured to secure the housing against rotation relative to an external structure.

20. The actuator housing of claim 13, wherein the columns are hollow columns.
